(19) United States
(12) Patent Application Publication
(10) Pub. No.: US 2016/0175944 A1
(43) Pub. Date: Jun. 23, 2016

(54) CUTTING TOOL WITH ASYMMETRIC STRUCTURES ON CUTTING TEETH

(71) Applicant: METAL INDUSTRIES RESEARCH & DEVELOPMENT CENTRE, Kaohsiung City (TW)

(72) Inventors: Yu-Ting Lyu, Kaohsiung City (TW); Yin Chuang, Kaohsiung City (TW); Zai-Fa Chen, Kaohsiung City (TW); Yin-Xian Chen, Kaohsiung City (TW); Hai-Qing Zou, Kaohsiung City (TW)

(73) Assignee: METAL INDUSTRIES RESEARCH & DEVELOPMENT CENTRE

(21) Appl. No.: 14/576,701

(22) Filed: Dec. 19, 2014

(51) Int. Cl. B23B 51/02; B23C 5/10

(52) U.S. Cl. CPC B23B 51/02; B23C 5/10; B23B 2226/315; B23B 2251/14; B23C 2210/086; B23C 2210/285; B23C 2210/54; B23C 2226/315

(57) ABSTRACT

A cutting tool with asymmetric structures on cutting teeth has multiple toothed surfaces. Each of the toothed surfaces has multiple groove structures dividing a side edge of the toothed surface into the cutting teeth. Since the groove structures of the toothed surfaces are arranged in an asymmetric and complementary manner, contact areas between the cutting teeth on the toothed surfaces of the cutting tool and a workpiece are reduced. The cutting teeth on the toothed surfaces of the cutting tool are not worn and broken easily. When the cutting tool is used for cutting hard brittle material, machining quality, accuracy, and efficiency are enhanced.

### BACKGROUND OF THE INVENTION

1. Field of the Invention

The present invention relates to a cutting tool, especially to a cutting tool with asymmetric structures on cutting teeth of the cutting tool.

2. Description of the Prior Art(s)

In precision machining industry or mold manufacturing industry, machining cutting of hard brittle material is mostly processed by electrical discharge machining or grinding. However, the machining processes are complicated and time-consuming, and therefore are economically inefficient for manufacturing.

With development of cutting tools, polycrystalline diamond (PCD) powders are used in the cutting tools for cutting the hard brittle material in order to shorten time for precision machining or mold manufacturing. U.S. Pat. No. 8,052,765 B2 discloses a PCD blade that can be formed with a pre-shaped mold. Multiple commaterial powders are pressurized and sintered to form the PCD blade. Then the PCD blade is attached to a shank or a holder of a cutting tool. U.S. Pat. No. 8,361,429 B2 discloses technical contents about manufacturing a PCD cutting tool. The technical contents are about influence of diamond grain size on forming the PCD cutting tool, how to form the cutting tool with the diamond grains under high temperature and high pressure, and the like.

However, during the processes for machining the hard brittle material, cutting force occurs between the cutting tool and the workpiece, and causes wear and break on the cutting teeth on the cutting tool. Accordingly, machining quality and accuracy of the workpieces are bad, such that the cutting tool cannot satisfy mass production.

To overcome the drawbacks, the present invention provides a cutting tool with asymmetric structures on cutting teeth of the cutting tool.

### SUMMARY OF THE INVENTION

The object of the present invention is to provide a cutting tool with asymmetric structures on cutting teeth. The cutting tool has a tool tip and multiple toothed surfaces. The tool tip is axially formed on an end portion of the cutting tool. The toothed surfaces are formed on the end portion of the cutting tool and are separately arranged around the tool tip. Each of the toothed surfaces extends between the tool tip and a side surface of the cutting tool and has multiple groove structures. The groove structures are formed in the toothed surface, are separately arranged between an inner end and an outer end of the toothed surface, are formed through a side edge of the toothed surface, and divide the side edge of the toothed surface into multiple cutting teeth.

Since the groove structures of the toothed surfaces are arranged in an asymmetric and complementary manner, contact areas and cutting force between the cutting teeth of the cutting tool and a workpiece are reduced. When the cutting tool is used for cutting hard brittle material, machining quality, accuracy, and efficiency are enhanced.

Other object, advantages and novel features of the invention will become more apparent from the following detailed description when taken in conjunction with the accompanying drawings.

### BRIEF DESCRIPTION OF THE DRAWINGS

FIG. 1 is an enlarged side view of a first embodiment of a cutting tool with asymmetric structures on cutting teeth in accordance with the present invention;

FIG. 2 is a schematic view of relative positions and relative lengths of groove structures and cutting teeth of the cutting tool in FIG. 1;

FIG. 3 is an enlarged operational side view of the cutting tool in FIG. 1; and

FIG. 4 is an enlarged side view of a second embodiment of a cutting tool with asymmetric structures on cutting teeth in accordance with the present invention.

### DETAILED DESCRIPTION OF THE PREFERRED EMBODIMENTS

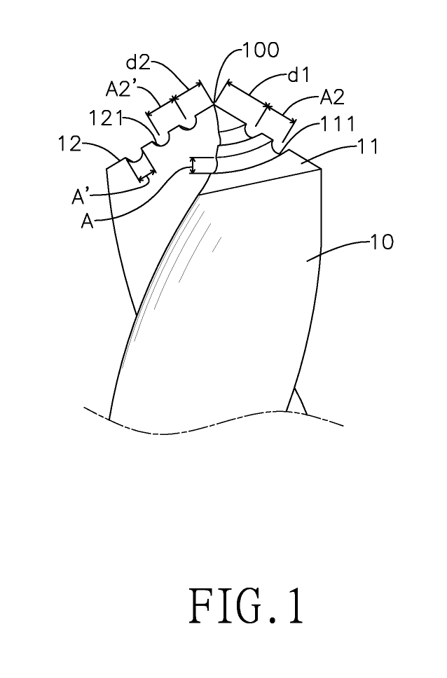

With reference to FIG. 1, in a first preferred embodiment, a cutting tool 10 with asymmetric structures on cutting teeth in accordance with the present invention is a drill bit made of polycrystalline diamond (PCD). The cutting tool 10 is cylindrical and comprises an end portion, a side surface, a tool tip 100, a first toothed surface 11, and a second toothed surface 12.

The tool tip 100 is axially formed on the end portion of the cutting tool 10. The first toothed surface 11 and the second toothed surface 12 are formed on the end portion and are separately arranged around the tool tip 100. Each of the first and second toothed surfaces 11, 12 extends between the tool tip 100 and the side surface and has a side edge, an inner end, and an outer end. The inner end is connected to the tool tip 100. The outer end is connected to the side surface.

The first toothed surface 11 further has multiple first groove structures 111. The first groove structures 111 are formed in the first toothed surface 11 and are separately arranged between the inner end and the outer end of the first toothed surface 11. The first groove structures 111 are formed through the side edge of the first toothed surface 11 and divide the side edge of the first toothed surface 11 into multiple cutting teeth. A first width A of each of the first groove structures 111 is less than 20 nm. The first groove structures 111 are equidistantly spaced. A spacing distance A2 defined between two of the first groove structures 111 that are disposed next to each other is twice as long as the first width A. In the first preferred embodiment, the first toothed surface 11 has two first groove structures 111. Each of the first groove structures 111 is semi-circular in cross-section.

The second toothed surface 12 further has multiple second groove structures 121. The second groove structures 121 are formed in the second toothed surface 12 and are separately arranged between the inner end and the outer end of the second toothed surface 12. The second groove structures 121 are formed through the side edge of the second toothed surface 12 and divide the side edge of the second toothed surface 12 into multiple cutting teeth. A second width A′ of each of the second groove structures 121 is less than 20 nm. The second groove structures 121 are equidistantly spaced. A spacing distance A2′ defined between two of the second groove structures 121 that are disposed next to each other is twice as long as the second width A′. In the first preferred embodiment, the second toothed surface 12 has three second groove structures 121. Each of the second groove structures 121 is semi-circular in cross-section.

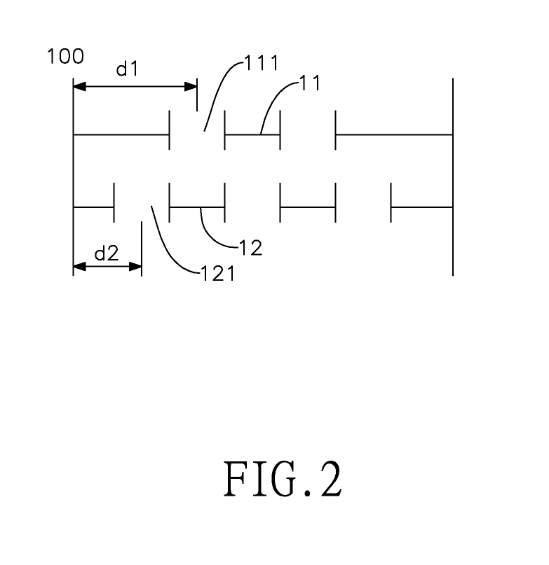

With further reference to FIG. 2, the cutting teeth on the first toothed surface 11 of the cutting tool are respectively positioned toward the second groove structures 121 of the second toothed surface 12. The cutting teeth on the second toothed surface 12 of the cutting tool are respectively positioned toward the first groove structures 111 of the first toothed surface 11. The first groove structures 111 of the first toothed surface 11 and the second groove structures 121 of the second toothed surface 12 are arranged in an asymmetric and complementary manner.

With reference to FIGS. 1 and 2, a first distance d1 is defined between the tool tip 100 and a center of one of the first groove structures 111 that is disposed next to the tool tip 100. A second distance d2 is defined between the tool tip 100 and a center of one of the second groove structures 121 that is disposed next to the tool tip 100. A length difference between the first distance d1 and the second distance d2 is greater than or equal to 0.5 time of the second distance d2, and is less than or equal to 0.95 time of the second distance d2.

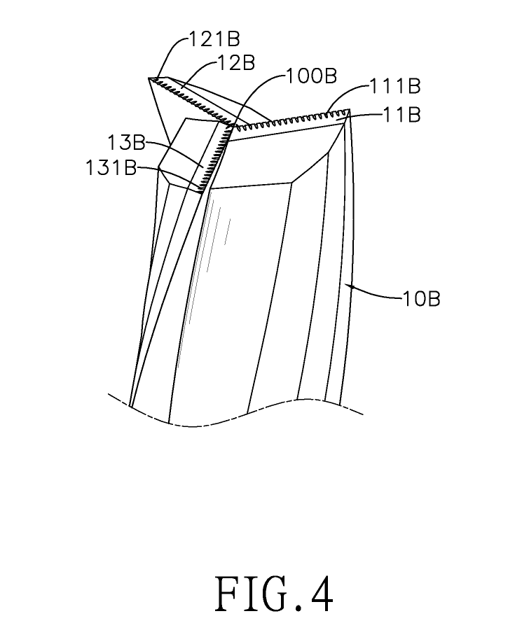

With reference to FIG. 4, in a second preferred embodiment, a cutting tool 10B with asymmetric structures on cutting teeth in accordance with the present invention is a milling cutter made of PCD. The cutting tool 10B comprises a side surface, a tool tip 100B, a first toothed surface 11B, a second toothed surface 12B, and a third toothed surface 13B.

Each of the first, second, and third toothed surfaces 11B, 12B, 13B has an inner end connected to the tool tip 100B and an outer end connected to the side surface. The first toothed surface 11B further has multiple first groove structures 111B. The first groove structures 111B are formed in the first toothed surface 11B and are separately arranged between the inner end and the outer end of the first toothed surface 11B. The second toothed surface 12B further has multiple second groove structures 121B. The second groove structures 121B are formed in the second toothed surface 12B and are separately arranged between the inner end and the outer end of the second toothed surface 12B. The third toothed surface 13B further has multiple third groove structures 131B. The third groove structures 131B are formed in the third toothed surface 13B and are separately arranged between the inner end and the outer end of the third toothed surface 13B.

Other features of the second preferred embodiment of the cutting tool 10B are the same as the features of the cutting tool 10 of the first preferred embodiment and therefore are omitted.

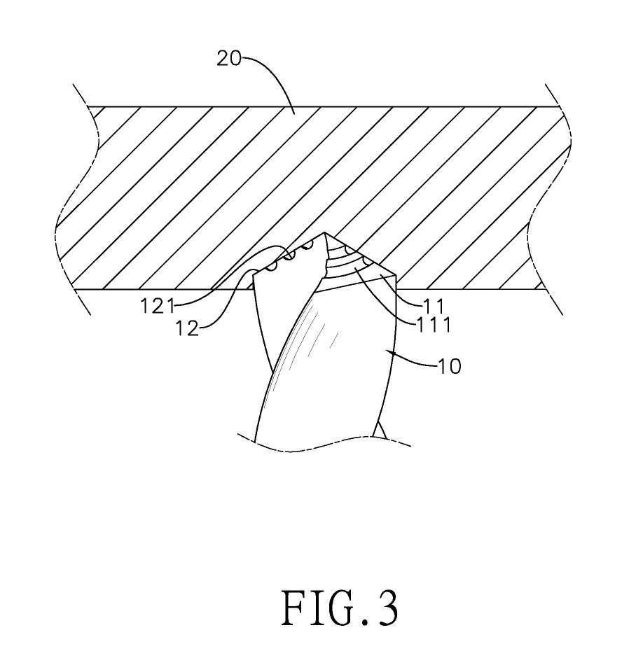

With further reference to FIG. 3, the drill bit of the first preferred embodiment of the cutting tool 10 is used for drilling holes on a workpiece 20. Since the first groove structures 111 formed on the first toothed surface 11 and the second groove structures 121 formed on the second toothed surface 12 are arranged in an asymmetric and complementary manner, contact areas between the cutting teeth on the first toothed surface 11 of the cutting tool and the workpiece 20 and between the cutting teeth on the second toothed surface 12 of the cutting tool and the workpiece 20 are reduced. Thus, cutting force that the workpiece 20 reacts on the cutting tool 10 is also reduced, and the cutting teeth on the first and second toothed surfaces 11, 12 of the cutting tool are not worn and broken easily.

Moreover, as the length difference between the first distance d1 and the second distance d2 is greater than or equal to 0.5 time of the second distance d2, and is less than or equal to 0.95 time of the second distance d2, portions of the workpiece 20 that are cut by the cutting teeth on the first toothed surface 11 of the cutting tool and portions of the workpiece 20 that are cut by the cutting teeth on the second toothed surface 12 of the cutting tool overlap. Therefore, even though the first groove structures 111 and the second groove structures 121 are asymmetrically formed in the first toothed surface 11 and the second toothed surface 12, the workpiece 20 can be cut without omitted portions and no burr would form on the workpiece 20.

Thus, when the cutting tool 10 is used for cutting hard brittle material, machining quality, accuracy, and efficiency are enhanced, so the cutting tool 10 is beneficial for mass production. Consequently, technical skill level of precision machining or mold manufacturing can also be enhanced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cutting tool comprising:
an end portion;
a side surface;
a tool tip axially formed on the end portion; and
multiple toothed surfaces formed on the end portion and separately arranged around the tool tip, each of the toothed surfaces extending between the tool tip and the side surface and having
a side edge;
an inner end connected to the tool tip;
an outer end connected to the side surface; and
multiple groove structures formed in the toothed surface, separately arranged between the inner end and the outer end of the toothed surface, formed through the side edge of the toothed surface, and dividing the side edge of the toothed surface into multiple cutting teeth, the groove structures being equidistantly spaced;
wherein the cutting teeth of one of the toothed surfaces are respectively positioned toward the groove structures of the other one of the toothed surfaces; and
the groove structures of the toothed surfaces are arranged in an asymmetric and complementary manner.

2. The cutting tool as claimed in claim 1, wherein
in one of the toothed surfaces, a first distance is defined between the tool tip and a center of one of the groove structures that is disposed next to the tool tip;
in the other one of the toothed surfaces, a second distance is defined between the tool tip and a center of another one of the groove structures that is disposed next to the tool tip; and
a length difference between the first distance and the second distance is greater than or equal to 0.5 time of the second distance, and is less than or equal to 0.95 time of the second distance.

3. The cutting tool as claimed in claim 1, wherein a width of each of the groove structures is less than 20 μm.

4. The cutting tool as claimed in claim 2, wherein a width of each of the groove structures is less than 20 μm.

5. The cutting tool as claimed in claim 3, wherein each of the groove structures is semi-circular in cross-section.

6. The cutting tool as claimed in claim 4, wherein each of the groove structures is semi-circular in cross-section.

7. The cutting tool as claimed in claim 5, wherein the cutting tool is made of polycrystalline diamond (PCD).

8. The cutting tool as claimed in claim 6, wherein the cutting tool is made of PCD.
